(19) United States
(12) Patent Application Publication
(10) Pub. No.: US 2015/0175158 A1
(43) Pub. Date: Jun. 25, 2015

(54) DRIVE ASSISTANCE FOR A MOTOR VEHICLE

(71) Applicant: GM GLOBAL TECHNOLOGY OPERATIONS LLC, Detroit, MI (US)

(72) Inventor: Nikolas Wagner, Eltville-Rauenthal (DE)

(21) Appl. No.: 14/575,714

(22) Filed: Dec. 18, 2014

(30) Foreign Application Priority Data
Dec. 20, 2013 (DE) 102013021641.9

(51) Int. Cl. B60W 30/00; B60W 30/14

(52) U.S. Cl. CPC B60W 30/00; B60W 30/14

(57) ABSTRACT

The present disclosure pertains to a method for operating a motor vehicle using a driver assistance system based on a kinematic setpoint. A relevant road section is determined from a plurality of road sections that are respectively linked with a road section-specific kinematic variable. Then, the kinematic setpoint is determined based on the kinematic variable that is linked with the determined relevant road section.

### CROSS REFERENCE TO RELATED APPLICATION

This application claims priority to German Patent Application No. 102013021641.9 filed Dec. 20, 2013, which is incorporated herein by reference in its entirety

### TECHNICAL FIELD

The technical field pertains to a driver assistance system for a motor vehicle, as well as a method for operating a motor vehicle with a driver assistance system and a computer program product for carrying out such a method.

### BACKGROUND

DE 10 2011 012 096 A1 discloses a method for operating a driver assistance system, in which a driver-specific acceleration value is determined and a speed of the motor vehicle is in a first phase controlled based on this driver-specific acceleration value.

### SUMMARY

In accordance with the present disclosure improved operation of a motor vehicle can be attained. In particular, a method for operating a motor vehicle with a driver assistance system is disclosed. According to an aspect of the present disclosure, a motor vehicle, particularly a passenger car, is at least intermittently operated in a semi-automated or fully automated fashion using a driver assistance system based on a kinematic setpoint. The motor vehicle, particularly a passenger car, features according to another aspect a driver assistance system that is designed for at least intermittently operating the motor vehicle in a semi-automated or fully automated fashion based on a kinematic setpoint.

In an embodiment, the driver assistance system or its operation may respectively feature, in particular, an automatic cruise control (“Cruise Control” or “CC”), in which the driver assistance system controls, according to an enhancement, a vehicle speed or a variable that influences this vehicle speed, particularly a vehicle acceleration, a driving power and/or braking power or the like, based on a desired kinematic setpoint, particularly a desired nominal speed and/or nominal acceleration.

Additionally or alternatively, the driver assistance system or its operation may respectively feature an automatic adaptive cruise control (“Adaptive Cruise Control” “ACC”), in which the driver assistance system controls, according to an enhancement, a vehicle speed or a variable that influences this vehicle speed, particularly a vehicle acceleration, a driving power and/or braking power or the like, based on a desired kinematic setpoint, particularly a desired clearance from a motor vehicle driving in front, a desired nominal speed and/or nominal acceleration.

According to an aspect of the present disclosure, a relevant road section is determined from a plurality of road sections, using a road section determination from the driver assistance system and/or in an at least partially automated fashion. The relevant road section is particularly selected from a plurality of road sections that are respectively linked with a road section-specific kinematic variable using storage technology due to corresponding allocation in a characteristic diagram or the like. The kinematic setpoint, which the driver assistance system operates the motor vehicle, is defined based on the kinematic variable that is linked with this determined relevant road section, particularly by a setpoint definition of the driver assistance system and/or in an at least partially automated fashion.

In an embodiment, the kinematic setpoint, based on which the driver assistance system operates the motor vehicle, can thereby be defined in a road section-specific fashion. Consequently, the operation of the driver assistance system and of the motor vehicle can be respectively improved in an embodiment of the present disclosure.

If the road section consists, for example, of a section of a highway without speed limit, a higher nominal speed, a greater nominal vehicle clearance or the like can be automatically defined for a cruise control or an adaptive cruise control. However, if the road section consists, for example, of a section of a secondary road with little traffic, a slower nominal speed, a shorter nominal vehicle clearance or the like can be automatically defined, for example, for a cruise control or an adaptive cruise control. In this way, the characteristic of the driver assistance system can be better adapted to the respective situation automatically.

In an embodiment, a kinematic setpoint that was road section-specifically defined in this way can be modified or discarded, particularly by the driver, for example by accelerating or decelerating the motor vehicle while a cruise control or an adaptive cruise control operates based on this road section-specifically defined kinematic setpoint or by intermittently or continuously increasing or decreasing the road section-specifically defined kinematic setpoint in the form of a manual input, e.g., by actuating a lever or the like.

In an embodiment, a road section-specific kinematic variable respectively is or may be defined beforehand, in particular, based on geographical data that is linked with the road section, with which this road section-specific kinematic variable is in turn linked. In this way, for example, a recommended highway speed may be linked with sections of a highway without speed limit as road section-specific kinematic variable beforehand and a respectively permissible maximum speed or suggested average speed, e.g., for so-called “phased traffic lights” may be linked with sections of a secondary road with little traffic. In this way, suitable and advantageous road section-specific kinematic variables can already be defined beforehand.

In an embodiment, a road section-specific kinematic variable may be additionally or alternatively determined, in particular, by a road section variable determination of the driver assistance system, particularly in an at least partially automated fashion, based on one or more previous operations of the motor vehicle on the road section, with which this road section-specific kinematic variable is linked, particularly based on a single or multiple previous drives along the road section with the motor vehicle.

For example, if the motor vehicle was driven along a certain road section once or several times with certain maximum, minimum or average speeds, a particularly sliding average value of these speeds can be determined as road section-specific kinematic variable and defined as nominal speed for a cruise control or adaptive cruise control when traveling along this road section anew.

Additionally or alternatively, a nominal speed that was defined in a cruise control or an adaptive cruise control by a driver during a single or multiple previous drives along the corresponding road section, for example, by a lever, an on-board computer menu or the like, or an average value of such nominal speeds during previous operations may be linked with this road section as road section-specific kinematic variable.

In an embodiment, a road section-specific kinematic variable can generally be determined based on a previous operation of the motor vehicle along the road section, with which this road section-specific kinematic variable is linked, by determining this road section-specific kinematic variable based on the kinematic setpoint(s) that the driver has defined, in particular manually, during a single or multiple previous drives along this road section and/or based on actual kinematic variables that have actually occurred during a single or multiple previous drives along this road section, i.e. particularly based on manually defined nominal speeds and/or actually occurred speeds for a single previous drive or an average value of these speeds for multiple previous drives along the corresponding road section.

In an embodiment, the road section-specific kinematic variable and therefore also the kinematic setpoint can in this way be advantageously determined and defined, particularly in a precise and/or practice-oriented fashion.

In an enhancement, a previous operation of the motor vehicle is selectively used or not used in the determination of the road section-specific kinematic variable. During a traffic jam on a highway section, for example, the driver can respectively deactivate or prevent the determination of a maximum speed, a minimum speed or an average speed for this section, as well as the consideration of this irregular, atypical speed in the determination of the road section-specific speed and therefore its consideration in a nominal speed for a cruise control or an adaptive cruise control. In an embodiment, a road section-specific kinematic variable accordingly is selectively determined based on a previous operation of the motor vehicle on the road section, with which this road section-specific kinematic variable is linked.

Varying the road section-specific kinematic variables for successive road sections can lead to an undesirably broad variation of the kinematic setpoint. In order to reduce this variation, in particular, a permissible acceleration of a cruise control or an adaptive cruise control is or can be correspondingly limited in an embodiment. Additionally or alternatively, smoothing of the kinematic setpoint, particularly low-pass filtering of the kinematic setpoint, may be carried out over several successive road sections. For this purpose, in particular, the kinematic setpoint can in an embodiment be defined based on the kinematic variable, with which the determined relevant road section is linked, and the kinematic variable(s) that respectively is or are linked with one or more road sections that, in particular, directly precedes or precede and/or follows or follow the determined relevant road section. In this way, for example, the kinematic setpoint for a relevant road section Xᵢ can be determined based on a speed vᵢ linked with this road section, a speed vᵢ₋₁ linked with the road section Xᵢ₋₁ that directly precedes the road section Xᵢ and/or a speed vᵢ₊₁ linked with the road section X₊₁ that directly follows the road section Xᵢ. For example, low-pass filtering of the kinematic setpoint can be carried out over several successive road sections in this way.

In addition to a specification of the kinematic setpoint based on the road section, the kinematic setpoint can in an embodiment also be defined based on the respective driver of the motor vehicle and therefore in a road section-specific and driver-specific fashion, particularly by the setpoint definition designed for this purpose. In an embodiment, the respective operation of the driver assistance system and of the motor vehicle can be additionally improved in this way. In an enhancement, road section-specific and driver-specific kinematic variables respectively are or can be determined and linked with corresponding road sections. The kinematic setpoint likewise may be defined in a driver-specific fashion based on the same road section-specific kinematic variables.

For example, if different drivers have previously driven the motor vehicle along the same road section with different speeds, these speeds can be respectively determined as road section-specific and driver-specific kinematic variables. It is likewise possible, for example, to define a nominal speed differently in dependence on the driver based on the same, merely road section-specific speed linked with a road section, for example, by multiplying the same, merely road section-specific speed with different driver-specific factors or the like.

For this purpose, in particular, the setpoint definition may feature a driver identification for identifying a driver such as, for example, for detecting an individualized ignition key, an input of a personal identity or the like.

In an embodiment, the determination of the relevant road section is selectively carried out. Alternatively or additionally, the road section-specific definition of the kinematic setpoint is selectively carried out in an embodiment. For this purpose, in particular, the driver assistance system may feature a correspondingly designed selection for selectively carrying out the determination of the relevant road section and/or the road section-specific definition of the kinematic setpoint, for example, in the form of a switch, an option of an on-board computer menu or the like.

In an embodiment, this enables the driver to select whether the driver assistance system operates the motor vehicle based on a global kinematic setpoint, particularly a factory-defined kinematic setpoint, or based on a road section-specific setpoint. In an embodiment, the determination of the relevant road section already can be selectively (de)activated, particularly in order to save computing capacity. In another embodiment, only the road section-specific definition of the kinematic setpoint may likewise be selectively (de)activated, but the relevant road section is still determined in order allow a faster reaction when the road section-specific setpoint is activated.

In an embodiment, the relevant road section is determined based on a determined current position of the motor vehicle. The relevant road section may, in particular, be the road section, on which the motor vehicle is currently operated or located, or the road section that currently lies closest to the motor vehicle. Likewise, the relevant road section may, in particular, be an imminent road section, on which the motor vehicle presumably will soon be operated or on which the motor vehicle presumably will soon be located, respectively.

For this purpose, in particular, the road section determination may in an embodiment feature a position determination means for determining a current position of the motor vehicle, particularly for receiving and processing GPS signals and for storing and/or retrieving, in particular, geographical map data.

A road section may be defined, for example, in accordance with the ADASIS (“Adaptive (map-enhanced) Drive Assistance System Interface Specification”) protocol. In an embodiment, a road section is a section of a road with fixed or variable length, along which the motor vehicle can be driven, particularly already has been driven, and is stored in or can be retrieved by the road section determination, in particular, in vector-based or coordinate-based form. In an embodiment, the driver assistance system accordingly features a storage device for storing road section-specific kinematic variables.

As already explained above with reference to the examples, the kinematic setpoint(s) and/or road section-specific kinematic variable(s) may in an embodiment include, particularly consist of, a (longitudinal) vehicle speed, a time derivative thereof, particularly a (longitudinal) vehicle acceleration, and/or a clearance from a vehicle driving in front. The various components and/or means in the context of the present disclosure may be implemented in the form of hardware and/or software technology, particularly a digital processing unit such as a microprocessor unit (CPU) that respectively is data-linked or signal-linked to a storage system and/or bus system, and/or feature one or more programs or program modules. The CPU may be designed for executing commands that are implemented in the form of a program stored in a storage system, for receiving input signals from a data bus and/or for delivering output signals to a data bus. A storage system may feature one or storage mediums, particularly different storage mediums such as optical, magnetic, solid-state and/or other non-volatile mediums. The program may be realized in such a way that it respectively embodies or is capable of carrying out the methods described herein such that the CPU can carry out the steps of such methods and, in particular, thusly operate the motor vehicle.

The present disclosure furthermore proposes a device for operating a motor vehicle with a driver assistance system based on a kinematic setpoint, with said device featuring: means for determining a relevant road section from a plurality of road sections that are respectively linked with a road section-specific kinematic variable; and means for defining the kinematic setpoint based on the kinematic variable that is linked with the determined relevant road section. In this case, the road section-specific kinematic variable can be determined, in particular selectively, based on at least one previous operation of the motor vehicle on the road section, with which this road section-specific variable is linked. The kinematic setpoint may in this case be defined based on the kinematic variable linked with a road section that precedes or follows the determined relevant road section.

The kinematic setpoint may furthermore be defined in a road section-specific and driver-specific fashion. In this case, the determination of the relevant road section and/or the road section-specific definition of the kinematic setpoint may be carried out selectively. The relevant road section may be determined based on a determined current position of the motor vehicle.

The kinematic setpoint and/or a road section-specific kinematic variable may include a vehicle speed and/or a time derivative thereof. In this case, the driver assistance system may feature a cruise control and/or an adaptive cruise control that operates based on the kinematic setpoint.

### BRIEF DESCRIPTION OF THEN

The present disclosure will hereinafter be described in conjunction with the following drawing figures, wherein like numerals denote like elements.

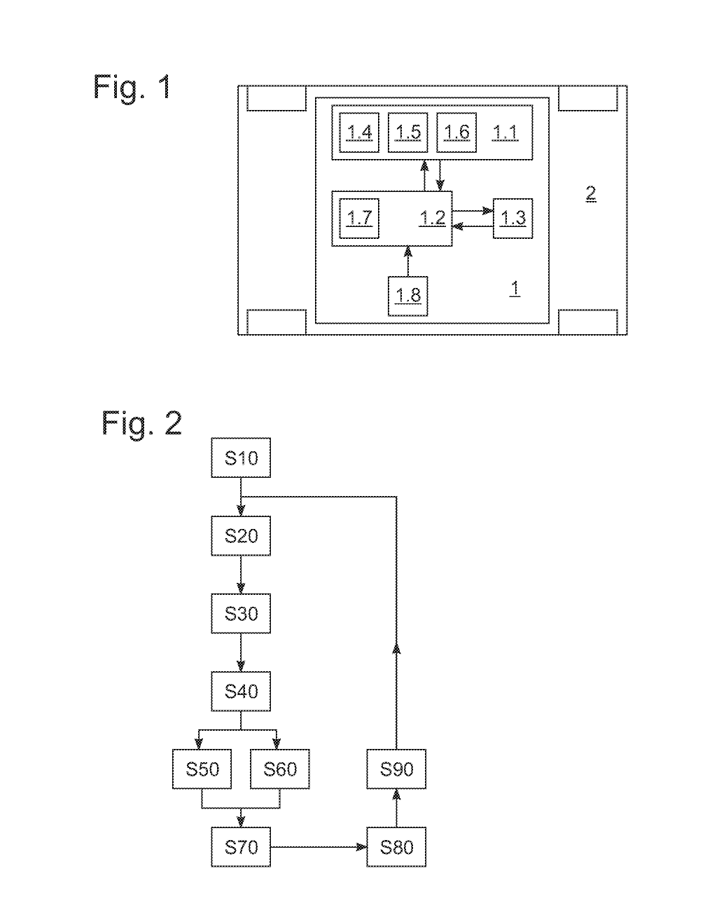

FIG. 1 shows a motor vehicle with a driver assistance system according to an embodiment of the present disclosure; and

FIG. 2 shows a method for operating the motor vehicle of FIG. 1 according to an embodiment of the present disclosure.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

FIG. 1 shows a passenger car 2 with a driver assistance system 1 according to an embodiment of the present disclosure, and FIG. 2 shows a method for operating the motor vehicle 2 according to an embodiment of the present disclosure, which is carried out by the driver assistance system 1.

In the exemplary embodiment, the driver assistance system 1 includes a cruise control 1.3 that controls a driving power of the passenger car 2 based on a kinematic setpoint in the form of a desired nominal speed v_{d}, namely in a manner that is not illustrated in greater detail. In a modified embodiment (not shown), the driver assistance system 1 may additionally or alternatively feature an adaptive cruise control that controls a driving power and a braking power of the passenger car 2 based on a one-dimensional or multi-dimensional kinematic setpoint in the form of a desired nominal speed and/or a desired clearance from a motor vehicle driving in front.

In a first step S10, a driver identification 1.7 identifies a driver of the passenger car 2, for example, by an individualized ignition key, an input of a personal identity or the like.

In a following step S20, the driver assistance system 1 determines whether it should operate the motor vehicle based on a global, factory-defined nominal speed v_{d0} or based on a road section-specific setpoint, namely on the basis of an input by a driver of the passenger car 2 with the aid of a selector 1.8, for example, in the form of a switch, an option of an on-board computer menu or the like.

In a following step S30, a position determination module 1.4 of a road section determination module 1.1 of the driver assistance system 1 determines the current position x of the motor vehicle 2 with the aid of GPS signals and geographical map data stored in a storage device or data store 1.5.

In a following step S40, the road section determination module 1.1 determines a relevant road section X from this current position x of the motor vehicle 2 by selecting the road section, on which the current position x is located or which lies closest to this position x, from several road sections Xᵢ, i=1, 2, . . . stored in the storage device 1.5.

In the storage device 1.5, each road section Xᵢ, i=1, 2, . . . is linked with a kinematic variable in the form of a speed vᵢ, i=1, 2, . . . that is specific to the respective road section, for example, using a characteristic diagram vᵢ=vᵢ(Xᵢ) or the like.

If the driver selected an operation based on road section-specific setpoints in step S20, the method or the driver assistance system 1 respectively continues with step S50 and otherwise with step S60.

In step S60, the global, factory-defined nominal speed v_{d0} is defined as desired nominal speed v_{d} (v_{d}=v_{d0}).

In step S50, in contrast, the speed linked with the relevant road section X is defined as desired nominal speed v_{d} (v_{d}=vᵢ(X)).

In a subsequent step S70, the desired nominal speed v_{d} is respectively multiplied with a driver-specific factor by means of the setpoint definition means 1.2 and in a following step S80 delivered to the cruise control 1.3 that then controls the driving power of the passenger car 2 based on the received nominal speed, for example, by varying the driving power proportionally to a deviation of a detected current longitudinal vehicle speed from this road section-specific and driver-specific nominal speed v_{d}.

After the motor vehicle was driven along the road section X, the average speed v reached during this drive is determined in a step S90 by a road section variable determination module of 1.6 of the driver assistance system 1. The specific kinematic variable vᵢ linked with this road section X is determined based on this previous drive of the motor vehicle, as well as a predefined number of these previous drives of the motor vehicle, along this road section X and linked with this road section X as new or updated road section-specific kinematic variable, as well as stored in the storage device 1.5, for the next drive along this road section X. Subsequently, the method or the driver assistance system 1 respectively returns to step S20. In a modified embodiment, the driver can selectively deactivate or prevent such an update of the road section-specific kinematic variable on the basis of a previous operation of the motor vehicle.

If the passenger car 2 was not yet driven along a road section such as, for example, a section of a highway or of a secondary road with little traffic in a city, the global, factory-defined nominal speed v_{d0} is also defined as nominal speed v_{d} for the cruise control while driving along this road section if an operation based on road section-specific setpoints was selected. However, if the passenger car was already driven along the road section once or several times and the average speed(s) reached was/were stored as road section-specific kinematic variable linked with this road section, if applicable in averaged form, the road section-specific kinematic variable linked with this road section, i.e. the average speed reached during a previous drive along this road section or, in particular, a sliding average of average speeds reached during multiple previous drives along this road section, is defined as nominal speed v_{d} for the cruise control while actually driving along this road section if an operation based on road section-specific setpoints is desired.

In this way, the nominal speed of the cruise control can be defined in a more precise and practice-oriented fashion and the performance of the driver assistance system 1 can thereby be improved, for example, in that a higher nominal speed is automatically defined when driving along a section of a highway than when driving along a section of a secondary road with little traffic in a city.

While at least one exemplary embodiment has been presented in the foregoing detailed description, it should be appreciated that a vast number of variations exist. It should also be appreciated that the exemplary embodiment is only an example, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents

1-15. (canceled)

16. A method for operating a motor vehicle using a driver assistance system based on a kinematic setpoint comprising:
determining a relevant road section from a plurality of road sections that are respectively linked with a road section-specific kinematic variable;
defining the kinematic setpoint based on the kinematic variable that is linked with the determined relevant road section; and
controlling an operating parameter of the motor vehicle based on the kinematic setpoint.

17. The method according to claim 16, further comprising determining a road section-specific kinematic variable based on at least one previous operation of the motor vehicle on the road section, with which this road section-specific kinematic variable is linked.

18. The method according to claim 16 further comprising defining the kinematic setpoint based on the kinematic variable linked with a road section that directly precedes or follows the determined relevant road section.

19. The method according to claim 16 further comprising defining the kinematic setpoint in a road section-specific and driver-specific fashion.

20. The method according to claim 16 further comprising selectively carrying out the determination of the relevant road section and/or the road section-specific definition of the kinematic setpoint.

21. The method according to claim 16 further comprising determining the relevant road section based on a determined current position of the motor vehicle.

22. The method according to claim 16 wherein the kinematic setpoint comprises at least one of a vehicle speed or a time derivative of the vehicle speed.

23. The method according to claim 16 wherein a road section-specific kinematic variable comprises at least one of a vehicle speed or a time derivative of the vehicle speed.

24. The method according to claim 16 wherein the driver assistance system comprises a cruise control that operates based on the kinematic setpoint.

25. The method according to claim 24 wherein the driver assistance system comprises an adaptive cruise control that operates based on the kinematic setpoint.

26. A computer program product with a program code is stored on anon-transitory machine-readable medium for carrying out the method according to claim 16.

27. A driver assistance system for operating a motor vehicle based on a kinematic setpoint, in accordance with the method of claim 16, wherein the system comprises:
road section determination means for determining a relevant road section from a plurality of road sections that are respectively linked with a road section-specific kinematic variable; and
a setpoint definition means for defining the kinematic setpoint based on the kinematic variable that is linked with the determined relevant road section.

28. The driver assistance system according to claim 27 further comprising road section variable determination means for determining a road section-specific kinematic variable based on at least one previous operation of the motor vehicle on the road section with which the road section-specific kinematic variable is linked.

29. The driver assistance system according to claim 27 further comprising a storage device configured to store road section-specific kinematic variables.

30. The driver assistance system according to claim 27, wherein the setpoint definition means comprises a driver identification means for identifying a driver, the driver assistance system being configured to define the kinematic setpoint in a road section-specific and driver-specific fashion.

31. The driver assistance system according to claim 27 further comprising selection means for selectively carrying out the determination of at least one of the relevant road section and the road section-specific definition of the kinematic setpoint.

32. The driver assistance system according to claim 27, wherein the road section determination means comprises a position determination means for determining a current position of the motor vehicle.
